(19) United States
(12) Patent Application Publication
(10) Pub. No.: US 2008/0088140 A1
(43) Pub. Date: Apr. 17, 2008

(54) Combination of door lever

(75) Inventors: Lien-Shi Huang, Kaohsiung (TW); Kuang-Chun Chiang, Kaohsiung Hsien (TW)

Correspondence Address: COOPER & DUNHAM, LLP, 1185 AVENUE OF THE AMERICAS, NEW YORK, NY, 10036, US

(73) Assignee: Taiwan Fu Hsing Industrial Co., Ltd.

(21) Appl. No.: 11/582,266

(22) Filed: Oct. 17, 2006

(51) Int. Cl. E05B 1/00

(52) U.S. Cl. 292/347

(57) ABSTRACT

A combination of door lever has a lever, a connecting tube and a combinative jointer. The lever has a front, a proximal end and a cylinder transversely formed on and protruding from the front at the proximal end. The cylinder has a distal end and a receiving recess formed in the distal end and having a circumferential wall. The connecting tube is mounted securely in the receiving recess to receive a lock core assembly connected with a latch and has an outer wall. The combinative jointer is mounted between the circumferential wall of the receiving recess and the outer wall of the connecting tube to securely mount the connecting tube in the receiving recess to protect the connecting tube from falling off from the cylinder when the lever is turned to lock or unlock a door.

### BACKGROUND OF THE INVENTION

1. Field of the Invention

The present invention relates to a door lever, and more particularly to a combination of door lever which has a reinforced structure.

2. Description of Related Art

A door lock is mounted in a door and has two sides, a latch and two openers. The latch is mounted in the door to selectively lock the door. The openers are mounted respectively on the sides of the door lock and are connected to the latch for people to drive the latch to open the door by turning the openers. The openers may be door levers, door knobs or the like, wherein the door levers are used more extensively because the door levers can be turned with less force.

A Conventional door lever has a lever body and a cylinder. The lever body has a proximal end. The cylinder is hollow, is formed on and protrudes transversely from the proximal end of the lever body and holds a lock core assembly connected to the latch. The conventional door lever is manufactured with a casting process. However, a mold used for forming the door lever must has a cavity with a complicated structure for forming the cylinder of the door lever, which result in difficulty in manufacturing the mold. Additionally, the lever body of the door lever manufactured with a casting process is substantially solid and increases material cost.

To overcome the aforementioned shortcomings of the conventional door lever, a conventional combination of door lever is developed. The combination of door lever has a lever and a connecting tube. The lever has a proximal end and a cylinder. The cylinder is transversely formed on and protrudes from the proximal end of the lever and has a distal end, a receiving hole and a limit notch. The receiving hole is formed in the distal end of the cylinder. The limit notch is formed in the distal end of the cylinder and communicates with the receiving hole. The connecting tube is mounted in the receiving hole in the cylinder of the lever for receiving a lock core assembly and has a cylinder surface and a limit protrusion. The limit protrusion is formed on and protrudes from the cylinder surface of the connecting tube and is mounted in the limit notch to mount the connecting tube securely in the receiving hole.

Thus, the lever and the connecting tube can be designed individually with a simplified structure to facilitate manufacture of the combination of door lever to reduce material cost. However, a large external force is imposed between the limit notch and the limit protrusion when the lever is turned and may detach the limit protrusion from the limit notch to cause the connecting tube falling off from the cylinder of the lever.

### SUMMARY OF THE INVENTION

The primary objective of the present invention is to provide a combination of door lever to mitigate or obviate the aforementioned problems.

The combination of door lever comprises a lever, a connecting tube and a combinative jointer. The lever has a front, a proximal end and a cylinder. The cylinder is integrally formed on and protrudes from the front of the lever at the proximal end of the lever and has a distal end and a receiving recess. The receiving recess is formed in the distal end and has a circumferential wall.

The connecting tube is rigidly mounted in the receiving recess in the cylinder of the lever to receive a lock core assembly which is connected with a latch of a door lock. The connecting tube has an outer wall. When the connecting tube is rotated, the lock core assembly drives the latch to lock or unlock the door lock. The combinative jointer is mounted between the circumferential wall of the receiving recess in the cylinder of the lever and the outer wall of the connecting tube to securely mount the connecting tube in the receiving recess in the cylinder to protect the connecting tube from falling off from the cylinder when the lever is turned.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a combination of door lever in accordance with the present invention;

FIG. 2 is a front view of the combination of door lever in FIG. 1;

FIG. 3 is a cross sectional side view of the combination of door lever along line 3-3 in FIG. 2;

FIG. 4 is a cross sectional top view of the combination of door lever along line 4-4 in FIG. 2;

FIG. 5 is a front view of a second embodiment of a combination of door lever in accordance with the present invention;

FIG. 6 is a cross sectional side view of the combination of door lever in FIG. 5;

FIG. 7 is a cross sectional side view of a third embodiment of a combination of door lever in accordance with the present invention with a welded layer mounted between a cylinder and a connecting tube of the combination of door lever; and

FIG. 8 is a cross sectional side view of a forth embodiment of a combination of door lever in accordance with the present invention with a welded layer mounted between a cylinder and a connecting tube of the combination of door lever and a distal end of the connecting tube extending out of the cylinder.

### DETAILED DESCRIPTION OF THE PREFERRED EMBODIMENT

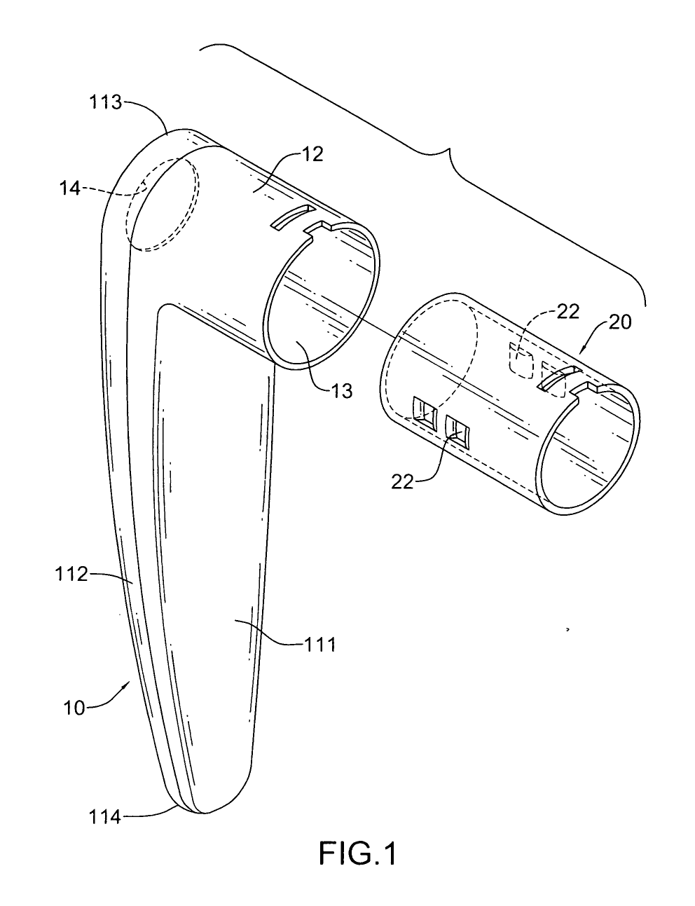

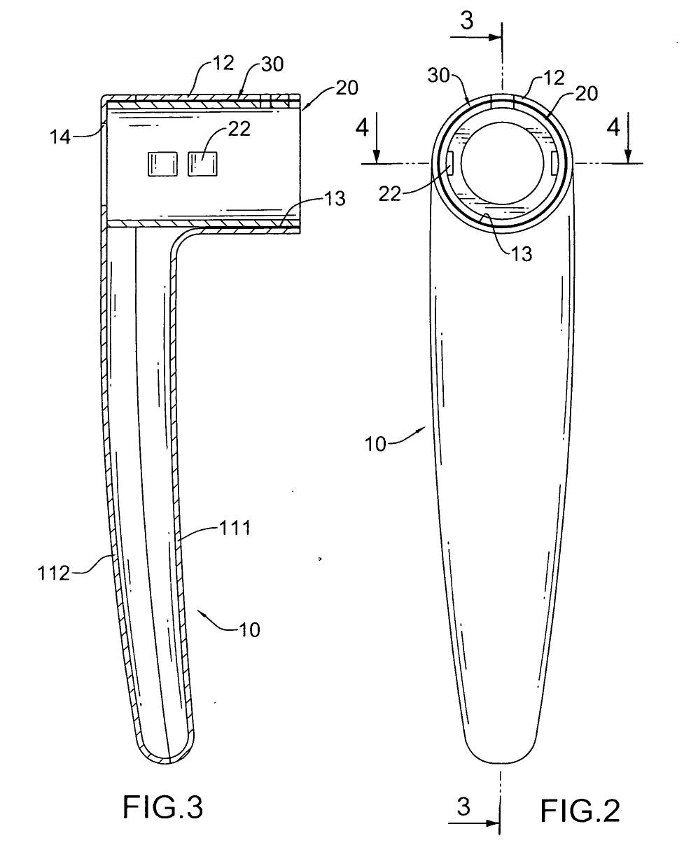

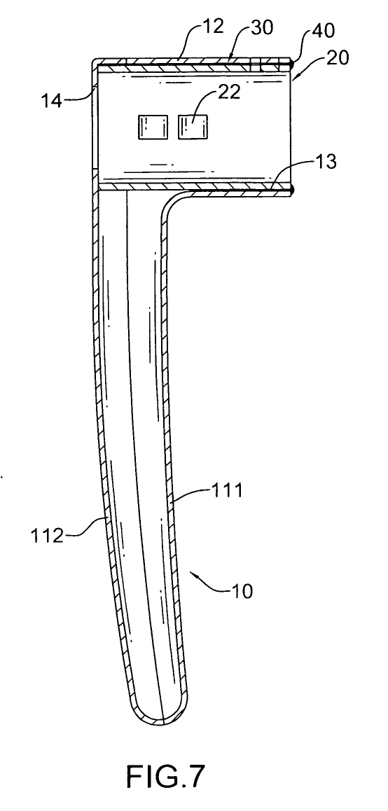

With reference to FIGS. 1-3 and 7-8, a combination of door lever in accordance with the present invention has a lever (10, 10′), a connecting tube (20, 20′) and a combinative jointer (30) and may have a welded layer (40). The lever (10, 10′) is hollow, has a rear, a front, a proximal end (113), a distal end (114), a cylinder (12, 12′) and an optional mounting hole (14) and may be implemented in several ways.

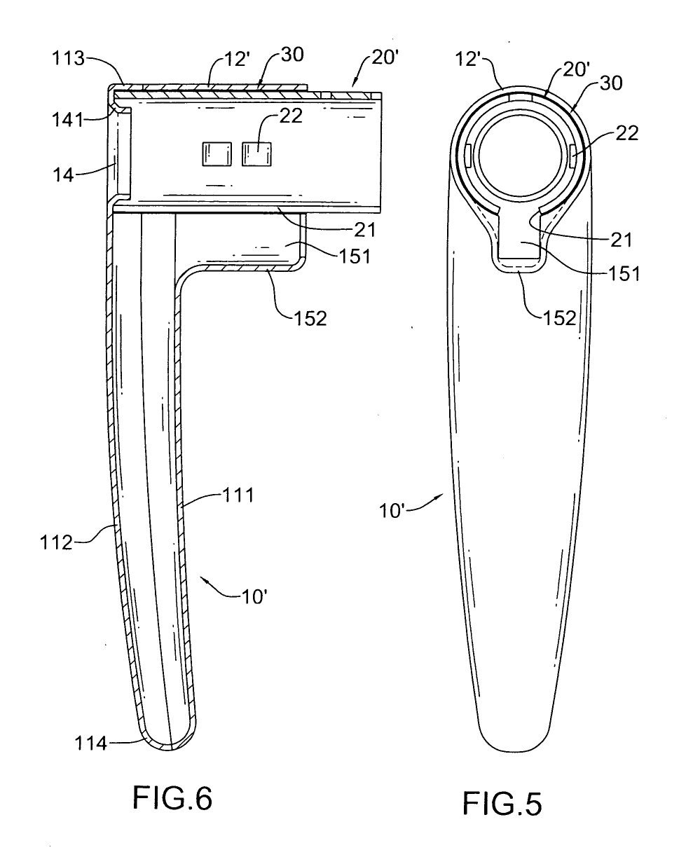

The cylinder (12, 12′) is hollow, is integrally formed on and protrudes from the front of the lever (10, 10′) at the proximal end (113) of the lever (10, 10′) and has a cross-section, a distal end, a receiving recess (13) and an optional protruding portion (152). The cross-section of the cylinder (12, 12′) is uniform and may be circular or noncircular. The receiving recess (13) is formed in the distal end of the cylinder (12, 12′) and has a circumferential wall. With reference to FIGS. 5 and 6, the protruding portion (152) extends toward the distal end of the lever and forms a retain recess (151). The retain recess (151) communicates with the distal end of the cylinder (12′).

The mounting hole (14) is formed in the rear of the lever (10, 10′) at the proximal end of the lever (10, 10′), communicates with the receiving recess (13) in the cylinder (12, 12′) and has a circumferential edge and an optional extended flange (141). The extended flange (141) is formed on and protrudes from the circumferential edge of the mounting hole (14) to the distal end of the cylinder (12′).

The lever (10, 10′) may be implemented with a front lever body (111) and a rear lever body (112). The front lever body (111) has a front, a rear and a proximal end. The cylinder (12, 12′) is formed on and protrudes from the front of the front lever body (111) at the proximal end of the front lever body (111). The rear lever body (112) has a front, a rear and a proximal end. The front of the rear lever body (112) corresponds to and is mounted on the rear of the front lever body (111). The mounting hole (14) is formed in the rear of the rear lever body (112) at the proximal end of the rear lever body (112).

The connecting tube (20, 20′) is rigidly mounted in the receiving recess (13) in the cylinder (12, 12′) of the lever (10, 10′) to rotate simultaneously with the lever (10, 10′) and to receive a lock core assembly of a door lock, which further has a latch connected to the lock core assembly and a driving tube. The connecting tube (20, 20′) has an inner wall, an outer wall, a distal end, at least one optional detent (22) and an optional retain notch (21) and may be implemented in several ways.

The at least one detent (22) is formed in the outer wall of the connecting tube (20, 20′) and protrudes from the inner wall of the connecting tube (20, 20′) to press against the cylinder (12, 12′) of the door lock. The retain notch (21) is formed in the distal end of the connecting tube (20, 20′) and aligns with the retain recess (151) so that the lock core assembly can extend through the retain notch (21) to be held and retained in the retain recess (151). The at least one detent (22) turns the driving tube to turn the lock core to drive the latch to lock or unlock the door lock when the connecting tube (20, 20′) is rotated.

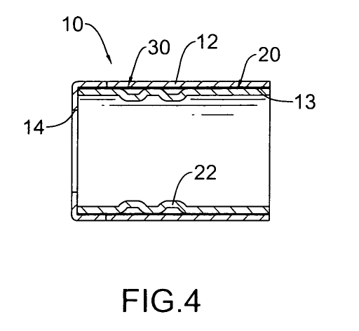

In a first embodiment of the connecting tube (20), with reference to FIGS. 3, 4 and 7, the distal end of the connecting tube (20) is flush with the distal end of the cylinder (12) of the lever (10).

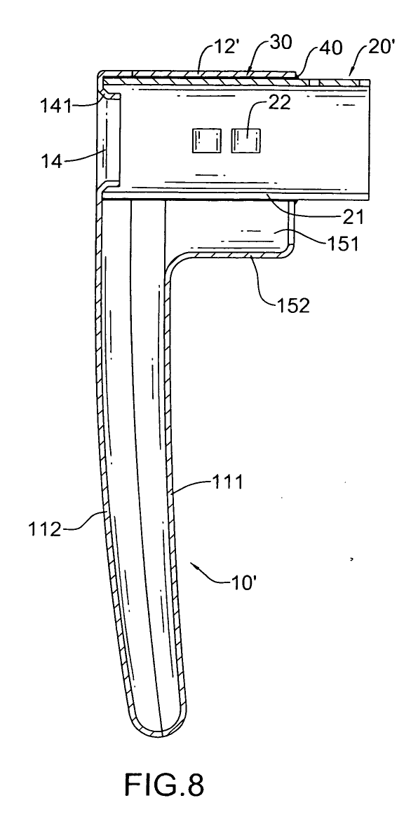

In a second embodiment of the connecting tube (20′), with reference to FIGS. 6 and 8, the distal end of the connecting tube (20′) extends out of the distal end of the cylinder (12′) of the lever (10′).

The combinative jointer (30) is mounted between the circumferential wall of the receiving recess (13) in the cylinder (12, 12′) of the lever (10, 10′) and the outer wall of the connecting tube (20, 20′). The combinative jointer (30) may be a solder jointer or an adhesive jointer to securely mount the connecting tube (20, 20′) in the receiving recess (13) in the cylinder (12, 12′).

The welded layer (40) is mounted between the distal end of the cylinder (12, 12′) of the lever (10, 10′) and the outer wall of the connecting tube (20, 20′) to mounted the connecting tube (20, 20′) securely in the receiving recess (13) in the cylinder (12, 12′). The welded layer (40) may encircle the distal end of the cylinder (12, 12′) or may include multiple welded drops distributed on the distal end of the cylinder (12, 12′).

Because the combinative jointer (30) is mounted between the circumferential wall of the receiving recess (13) in the cylinder (12, 12′) of the lever (10, 10′) and the outer wall of the connecting tube (20, 20′) with a large area, the connecting tube (20, 20′) can be mounted securely in the receiving recess (13) and does not fall off from the cylinder (12, 12′) when the lever (10, 10′) is turned.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A combination of door lever comprising:
a lever being hollow and having a rear, a front, a proximal end, a distal end and a cylinder, the cylinder being hollow, integrally formed on and extending from the front of the lever at the proximal end of the lever and having a distal end and a receiving recess, the receiving recess being formed in the distal end of the cylinder and having a circumferential wall;
a connecting tube rigidly mounted in the receiving recess in the cylinder of the lever and having an inner wall, an outer wall and a distal end; and
a combinative jointer mounted between the circumferential wall of the receiving recess in the cylinder of the lever and the outer wall of the connecting tube so as to securely mount the connecting tube in the receiving recess in the cylinder.

2. The combination of door lever as claimed in claim 1, wherein the lever further has a mounting hole formed in the rear of the lever at the proximal end of the lever, communicating with the receiving recess in the cylinder and having a circumferential edge.

3. The combination of door lever as claimed in claim 2, wherein the lever includes
a front lever body having a front, a rear and a proximal end, wherein the cylinder is formed on and protrudes from the front of the front lever body at the proximal end of the front lever body; and
a rear lever body having a front, a rear and a proximal end, wherein the front of the rear lever body corresponds to and is mounted on the rear of the front lever body, and the mounting hole is formed in the rear of the rear lever body at the proximal end of the rear lever body.

4. The combination of door lever as claimed in claim 2, wherein
the cylinder further has a protruding portion extending toward the distal end of the lever and forming a retain recess communicating with the distal end of the cylinder; and
the connecting tube further has a retain notch formed in the distal end of the connecting tube and aligning with the retain recess.

5. The combination of door lever as claimed in claim 4, wherein the distal end of the connecting tube extends out of the distal end of the cylinder of the lever.

6. The combination of door lever as claimed in claim 2, wherein the mounting hole further has an extended flange formed on and protruding from the circumferential edge of the mounting hole to the distal end of the cylinder.

7. The combination of door lever as claimed in claim 1, wherein the connecting tube further has at least one detent formed in the outer wall of the connecting tube and protruding from the inner wall of the connecting tube.

8. The combination of door lever as claimed in claim 1, wherein the combinative jointer is a solder jointer.

9. The combination of door lever as claimed in claim 1, wherein the combinative jointer is an adhesive jointer.

10. The combination of door lever as claimed in claim 1 further having a welded layer mounted between the distal end of the cylinder of the lever and the outer wall of the connecting tube.
